(19) United States
(12) Patent Application Publication
(10) Pub. No.: US 2011/0013189 A1
(43) Pub. Date: Jan. 20, 2011

(54) Adjustable Interference Filter

(75) Inventors: Ib-Rune Johansen, Oslo (NO); Alain Ferber, Haslum (NO); Håkon Sagberg, Oslo (NO)

Correspondence Address: ROTHWELL, FIGG, ERNST & MANBECK, P.C., 1425 K STREET, N.W., SUITE 800, WASHINGTON, DC, 20005, US

(73) Assignee: SINVENT AS, Trondheim (NO)

(21) Appl. No.: 12/839,215

(22) Filed: Jul. 19, 2010

Related U.S. Application Data
(63) Continuation of application No. 11/911,160, filed on Oct. 10, 2007.

(30) Foreign Application Priority Data
Apr. 15, 2005 (NO) 2005 1851

(51) Int. Cl. G01N 21/01

(52) U.S. Cl. 356/437

(57) ABSTRACT

The present invention relates to an adjustable interference filter, especially for use in gas detection with infrared light within a chosen range, comprising at least two essentially parallel reflective surfaces separated by a chosen distance defining a cavity delimited by the reflective surfaces between which the light may oscillate, and at least one of said surfaces being semitransparent for transmission of light to or from the cavity. The filter comprises a transparent material with a chosen thickness and having a high refractive index positioned in the cavity, and adjustable separation means for adjusting the cavity length between the reflecting surfaces, so as to obtain a cavity constituted by the transparent, high refractive index material and a an adjustable part.

### CROSS-REFERENCE TO RELATED APPLICATION

This application claims priority under 35 U.S.C. §120 from U.S. patent application Ser. No. 11/911,160, filed on Oct. 10, 2007, which claims priority under 35 U.S.C. §371 to International Application No. PCT/NO06/000124, filed Apr. 3, 2006, which claims priority to Norwegian Patent Application Ser. No. 2005.1851 filed on Apr. 15, 2005, the respective disclosures of which are hereby incorporated by reference.

### FIELD OF THE INVENTION

This invention relates to an adjustable interference filter, especially for use in gas detection with infrared light within a chosen range.

### DESCRIPTION OF RELATED ART

Most gases absorb infrared light with photon energies corresponding to the vibrational transitions of the gas molecule. When measuring gas concentrations with infrared light it is usual to perform two measurements of the light transmitted through the gas: One measurement being influenced (reduced) by gas absorption and one reference measurement which is not affected by the gas. This measuring method is sometimes referred to as non-dispersive infrared (NDIR).

As illustrated in FIG. 1, which shows the transmission as a function of the wavelength in the range of 4.5-5.0 μm, the infrared spectrum of carbon monoxide (CO) has an almost periodic line pattern. Several gases, including methane (CH₄), have similar absorption lines. The distance between the CO lines increase with increasing wavelength, but is essentially constant within a small interval of wavelengths. In order to measure the concentration of CO one may use an assembly as illustrated in FIG. 2. Light from an infrared source 21 is sent via a focusing mirror 22 through a gas cell 23 and further through a modulated filter 24, e.g. a Fabry-Perot filter, and a fixed band pass filter 25, and further through a new focusing mirror 26 to a detector 27. In this line up the function of the modulated filter is to shift between two configurations or settings. In one setting it transmits light in the spectral range where the CO transmits light (correlation setting) and in the other setting the it transmits light in the range where the CO absorbs light (anti-correlation setting). In this way it is possible to shift continuously between measurements using the different settings. The difference between the two settings will be zero when CO is not present in the gas cell, and will increase with increasing concentration of CO.

By using a filter being adapted to single lines in the gas spectrum several advantages may be obtained:

1) A given gas concentration gives a larger relative change in the measured signal, compared to when a band pass filter is used.

2) If other gases are present in the area which absorbs within the same wavelength range these will have minimal influence on the measurements, as one reduces the sensitivity for gases in the same range but with different lines.

3) Changes in the source temperature and other disturbances will also affect both measurements to the same degree.

For this to work everything except the position of the filter lines must be kept constant. This may be obtained by letting the light follow as similar paths as possible. Preferably everything affecting the measurements should have the same influence on them. In addition to other gases influences may be temperature gradients, dirt deposited on optical surfaces, drift in amplifier circuits, mechanical stability etc.

It is difficult to make a filter which fits directly with the CO lines. A good approximation is an interference filter having two parallel optical surfaces with a distance d between the surfaces, and a refractive index n for the medium between the surfaces. The transmission through the filter is then a periodic function of the wave number ν=1λ, where λ is the wavelength. The period is ½ nd, where n is the refractive index. Now the distance d, may be chosen so that the period corresponds with the CO lines in one range in the spectrum. When the optical wavelength s=nd is changed with one fourth of the wavelength:: s±(Δs)=s±λ/4, the required modulation of the filter is obtained. With a constant refractive index this will correspond to a change in thickness d±(Δd)=d±λ/4n. When the refractive index is 1, Δd will be approximately 2.3 μm.

The transmission through an interference filter in anti correlation mode, adapted to the CO spectrum, is illustrated in FIG. 1, where the upper line shows the CO spectrum and the lower line shows the transmission spectrum of the filter, both as functions of the wavelength, which is in the range of 4.5 to 5.0 μm.

Out from the centre wavelength a gradually increasing deviation will occur between the filter lines and the gas lines, as shown in FIG. 1. By adding a band pass filter one can delimit the range which is used.

If the interference filter is to consist of two parallel mirrors with an adjustable distance, the choice in optical materials between the mirrors is very limited: Air, other gases or possibly an elastic, transparent material. The optical material in the interference filter dictates how large angular spread one may have in the incoming light. When the angle increases the effective optical wavelength will decrease for the interfering light, and s spread in the incident angles will result in a smearing of the transmission spectrum. A high refractive index will give a low maximum refracted angle inside the filter. The maximum allowed angle will decide the etendue of the filter. Etendue is the product of area and solid angle of the light bundle, a measure of how much light it is possible to get through the system when the radiation source has unlimited extension. It can be shown that for a given spectral resolution the etendue is proportional to the square of the refractive index. Thus one may get 10 times more light if e.g. silicon is used (n=3.4) instead of air in the resonator.

The challenge is to make an interference filter with high refractive index, which also may change the optical wavelength enough to adjust the filter into both correlation and anti-correlation modes.

Previous Work.

The principle of measuring carbon monoxide with such an interference filter is described in U.S. Pat. No. 3,939,348 from 1974. It is also mentioned the possibility for making a thermally modulated filter in a transparent optical material, but silicon or similar is not mentioned.

It is expensive to make a mechanical interferometer, and therefore this measuring method has been unsuitable for cheap, mass produced CO sensors for use e.g. in fire alarms for the home market and process monitoring of incinerators.

Around 1990 Michael Zochbauer did some experiments with heating of a silicon disc for changing the optical wavelength [Zochbauer, article]. This way the interference filter becomes a cheap component. The heating and cooling cycle turned out to be slow and energy consuming. Also, it was difficult to achieve a uniform temperature over the disc.

### SUMMARY OF THE INVENTION

Thus it is an object of this invention to provide an adjustable interference filter with maximum light throughput which also makes it possible to perform correlation and anti correlation measurements under as similar situations as possible, e.g. by fast switching between two interference conditions.

These objects are obtained using an adjustable filter according to the accompanying claims.

### DESCRIPTION OF THE DRAWINGS

The invention will be described in more detail below with reference to the accompanying drawings which illustrates the invention by way of examples.

FIG. 1 illustrates as mentioned above the transmission spectrum for CO, and for a Fabry-Perot filter.

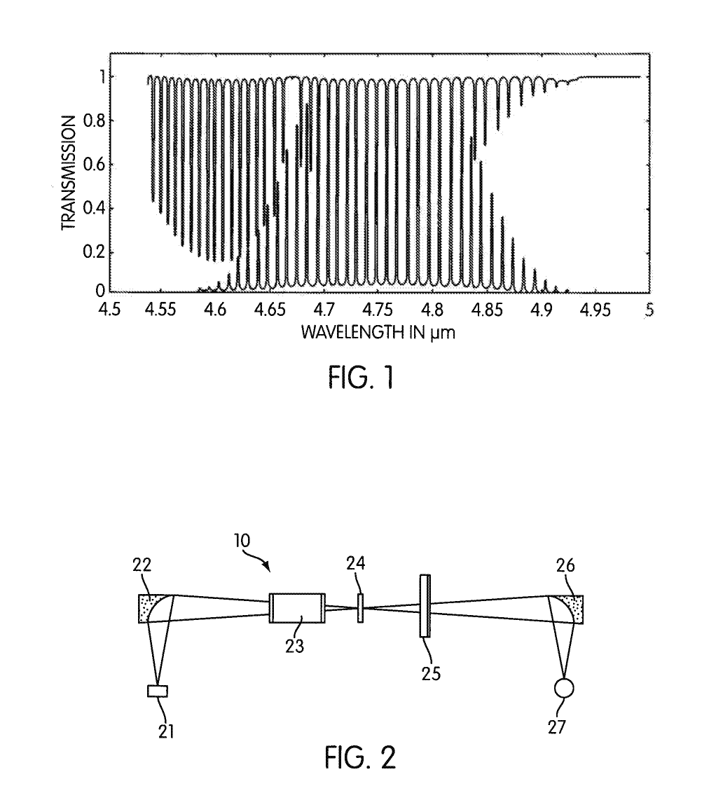

FIG. 2 illustrates as mentioned above a usual assembly for performing gas measurements according to the known art.

FIG. 3A-D illustrates alternative embodiments of the present invention, as well as the optical equivalent of this embodiment.

FIG. 4 illustrates a micromechanical embodiment of the invention.

FIG. 5A-B illustrates an alternative embodiment of the invention.

FIG. 6 illustrates an embodiment of the invention having a focusing pattern on a surface.

### DETAILED DESCRIPTION OF THE INVENTION

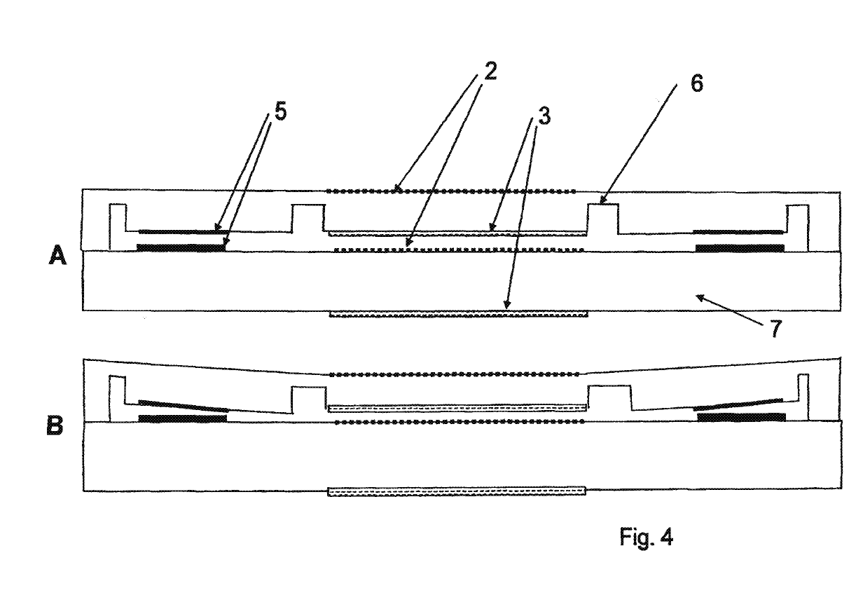

In FIGS. 3B and 3C an interference filter is illustrated consisting of two silicon discs I,II. The dominating interference of the light 10 oscillating in the filter is between the two transitions 2 between silicon and air. On the other side of the discs an anti reflection layer 3 is position. The result of this is that the interference filter will act like a single silicon disc 1, except for an “invisible” cavity, so that the optical equivalent situation becomes like the one illustrated in FIG. 3A, in which the interference filter is illustrated as a silicon disc 1 with a reflecting surface 2 on both sides. By changing the cavity, meaning the distance between the discs I,II in FIG. 3B, the total optical path length between the reflecting surfaces providing the interference will change. Then the filter may be set in both correlation and anti-correlation modes, so that one achieves the flexibility of an interferometer using cavity and mirrors, at the same time as the advantages of the silicon material are maintained, i.e. high angles of incident and reduced total thickness. The reduced thickness and short cavity distance makes it generally easy to make parallel surfaces. As is evident from the drawings the difference between FIGS. 3B and 3C is only that one silicon disc is turned, only affecting the optical path length between the two reflecting surfaces.

The cavity only has to be large enough to enable practical adjustment in the range of λ/4 to λ/2, depending on the tolerance and stability of the actual embodiment.

The material used is preferably silicon, but it is also possible to achieve good results with other materials. One example is Germanium, which has an even higher refractive index than silicon. In an alternative embodiment the variable cavity may be filled, e.g. with a gel having a suitable refractive index, in order to increase the efficiency of the filter even more. In ordinary uses it will, however, contain air.

The reflective layer will usually consist of plane and essentially parallel surfaces between air and the material, which for silicon will give a reflectance of about 0.3, but different surface treatments may be contemplated for tuning the finesse of the filter. The anti-reflection layer or reflection reducing surface may consist of one or more layers of different refractive indexes. This is per se known technology and will not be described in any detail here, but may be provided as a 0.65 μm layer of SiO with operation at wavelengths in the range of 4.75 μm. Other techniques such as porous silicon or gradual transitions in refractive index may also be used. The most important characteristic is that it has minimal reflection coefficient for the wavelength range of interest. The remaining reflection coefficient will affect the two measurements differently. Interference from one layer may be reduced even more by making one surface 4 rough or inclined, as illustrated in FIG. 3D.

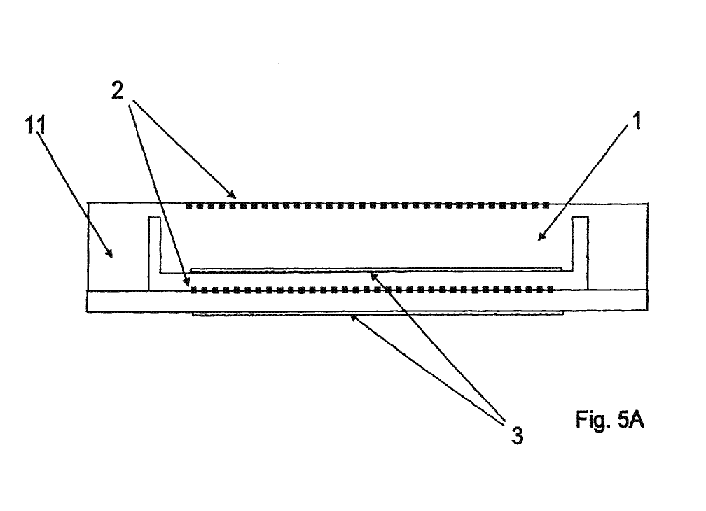

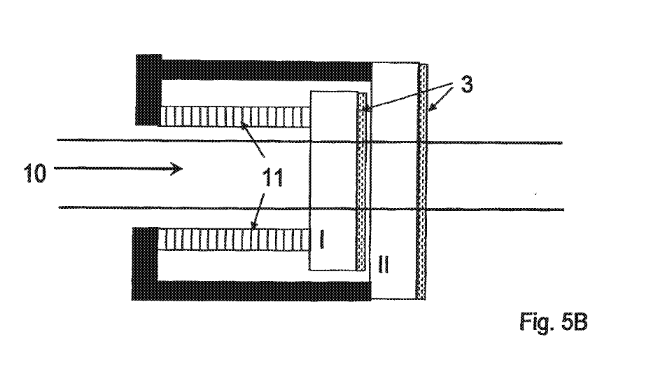

FIGS. 4 and 5 illustrates how the filter is thought to be implemented based on per se known solutions for wafer bonding and micromachining. As is evident from FIG. 4 the filter here is constituted by a substrate 6 with a disc being held at a chosen distance over the substrate. By applying an electrical voltage between the silicon disc 6, which constitutes one of the reflectors and the transparent material in the filter, and the underlying substrate 7 with the second reflector, one may adjust the distance between them with electrostatic attraction. Thus the thickness of the cavity is changes in a simple way. In FIG. 4 the dimensions in the different directions are, for the purpose of illustration, out of proportions for a practically realizable embodiment.

FIG. 4 illustrates a section of a preferred embodiment of the invention comprising an adjustable Fabry-Perot filter with electrostatic movement of the elements using the electrodes 5 coupled to a suitable voltage source (not shown). With electrostatic attraction between the overlying disc 6 and the substrate 7 the disc is pulled down and the cavity between them becomes smaller. This may be realized by photolithographic mass production based on wafer bonding and polishing.

FIGS. 5A and 5B illustrates an alternative principle wherein the thickness of the cavity is adjusted using a piezoelectric actuator 11. As evident from FIG. 5B the light 10 passes through the Fabry-Perot, so that the light falls in from one side and the light transmission may be measured on the other side of the filter. Both the disc and the substrate may be provided with a reflecting surface and a reflex reducing layer on the other side. The order of these may be varied as long as the cavity as well as at least one disk of silicon is found between the reflecting layers. These considerations may of course also be done in relation to the solution illustrated in FIG. 4. In addition to these solutions the distance between the reflecting layers may of course also be adjusted by choosing temperature, as described in the known art, possible for coarse adjustment to the measuring range of interest. Thus the resulting means for adjusting the optical path length through the filter will comprise a combination of temperature and distance control.

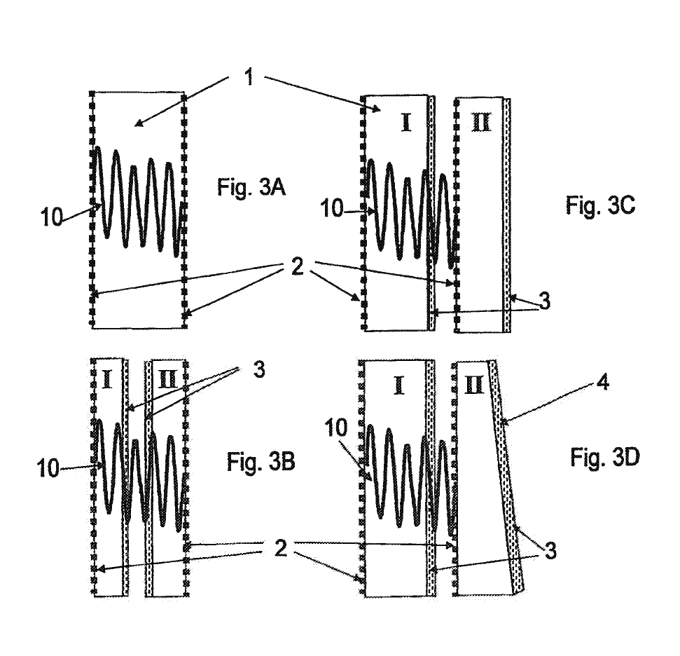

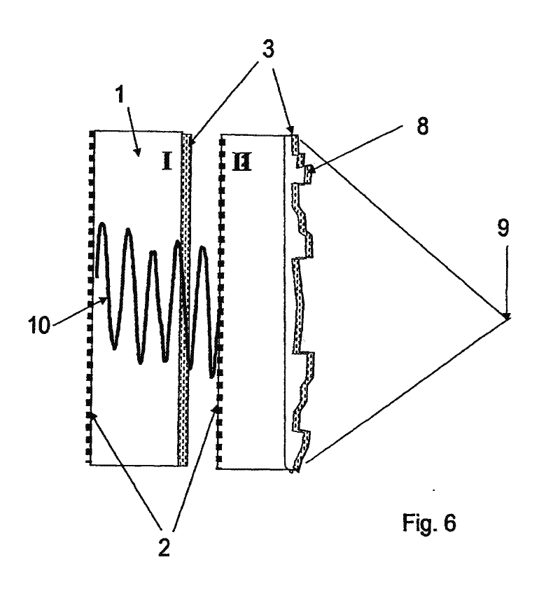

In addition to the solutions shown here the silicon disc may be provided with a pattern, e.g. for focusing the light passing through the element. This may be diffractive patterns, Fresnel lenses or zone plates 8 as illustrated in FIG. 6 where the light also passes through the filter and is focused toward a point. This may replace the other filter types in the optical system illustrated in FIG. 2, and may thus reduce the complexity of and requirements for adjustment between the different components.

According to another embodiment of the invention the silicon disc, in addition or as an alternative, may be provided with a larger pattern of reflecting surfaces for providing different cavity distances in different positions on the disc. In this way the different parts of the light spectrum may be analyzed in different positions on the disc, and possible diffractive lenses may aim the light in different directions for separate analysis. This will give a possibility for parallel analysis of different ranges of wavelengths in the light, and is treated more specifically in the simultaneously filed Norwegian patent application No. 2005.1850, and the international application filed with priority from said application, being included here by way of reference.

### REFERENCES

1. Barrett J J. 1974. U.S. Pat. No. 3,939,348

2. Rabbett M D. 1997. U.S. Pat. No. 5,886,247

3. Zochbauer M. 1994. Technisches Messen 61: 195-203

1. A method for detecting a concentration of carbon monoxide (CO) by detecting optical characteristics of light passing through a space that may or may not contain CO using an adjustable interference filter adapted for gas detection with infrared light within a predetermined range of wavelengths, the method comprising:
switching the interference filter between a first configuration which transmits light in a spectral range in which CO transmits light and a second configuration which transmits light in a spectral range in which CO absorbs light;
wherein the adjustable interference filter comprises:
a defined light path;
at least two essentially parallel reflective surfaces positioned in said light path and separated by a predetermined distance defining a resonator delimited by the reflective surfaces between which the light may oscillate, at least one of said surfaces being semitransparent for transmission of light to or from the resonator;
a first transparent material positioned between said reflective surfaces in said light path wherein the first transparent material have a predetermined thickness and a predetermined refractive index equal to the refractive index of silicon or higher;
separation means for defining a cavity between the first transparent material and at least one of the reflective surfaces;
adjustment means for adjusting the distance between said reflective surfaces and thus adjusting an optical path length of the resonator; and
an interface surface between said transparent material and said cavity in said light path, comprising reflection reducing means for reducing reflectivity of said interface surface in said range of wavelengths.

2. The method according to claim 1, wherein a first of the reflective surfaces constitutes one side of said transparent material, said interface surface having reduced reflectivity being positioned on the opposite side of said transparent material, and a second of the reflective surfaces is positioned on a carrier material on the opposite side of said cavity.

3. The method according to claim 2, wherein said first transparent material is constituted by a disc positioned over said second reflective surface, so that the first reflective surface is on the upper side of the disc and the reflection reducing means is positioned on the lower side of the disc.

4. The method according to claim 3, wherein the adjustable interface filter further comprises coupling means for coupling to a voltage source and electrical conductors related to each of the two reflective surfaces, thus to provide electrostatic adjustment of the distance between them.

5. The method according to claim 1, wherein at least one of said reflective surfaces comprises a three dimensional pattern, wherein said pattern constitutes at least one diffractive lens adapted to focus light with different wavelengths toward different points.

6. The method according to claim 1, wherein said cavity is filled with a flexible material comprising a gel having a chosen refractive index.

7. The method according to claim 1, wherein said interface with reduced reflectivity comprises at least one layer of materials having a refractive index being different from the refractive index of the cavity and of the transparent material, and with a thickness which reduces reflections at said interface within the chosen range of wavelengths.

8. The method according to claim 1, wherein a transmission spectrum of the interference filter is adjusted so as to essentially overlap an absorption spectrum of carbon monoxide over at least a portion of the chosen range of wavelengths.
